(19) United States
(12) Patent Application Publication
(10) Pub. No.: US 2003/0212619 A1
(43) Pub. Date: Nov. 13, 2003

(54) Targeting customers

(76) Inventors: Vivek Jain, New Delhi (IN); Raghuram Krishnapuram, New Delhi (IN); Krishna Kummamuru, New Delhi (IN)

Correspondence Address: McGinn & Gibb PLLC, 2568 A Riva Road, Suite 304, Annapolis, MD, 21401, US

(21) Appl. No.: 10/144,125

(22) Filed: May 10, 2002

(51) Int. Cl. G06F 17/60

(52) U.S. Cl. 705/35

(57) ABSTRACT

Identifying customers interested in a product involves identifying the attributes of the product and aggregating fuzzy sets associated with each of the identified product attributes. Any attribute for which one can estimate the interest of customers, such as tangible and non-tangible product attributes, can be used to determine customer interest. Conversely, customer attributes can be used to predict products in which customers are likely to be interested. Thus, a unified approach for linking both customer and product spaces through customer characteristics and product attributes is described.

### FIELD OF THE INVENTION

The present invention relates to targeting customers, and particularly but not exclusively to targeting customers for products using fuzzy logic techniques.

### BACKGROUND

Various methods exist for targeting products to customers. The targeting problem involves two aspects: (i) given a customer, finding the right kind of products to target to the customer, and (ii) given a product, finding suitable customers to target to that product.

Most targeting methods are based either on customer characteristics or product characteristics. For example, database marketing typically uses a set of customer attributes and product descriptions, and matches customers with products in a particular manner.

Many targeting tools place considerable emphasis on purchase history or customer demographics. Such tools rarely use information other than purchase history. Other information, such as other products that were checked by the customer before the customer made the final purchase, can improve the understanding of the customer's intentions.

The purchase decision of a customer depends on a variety of factors. These factors include, for example, product attributes, relative value of these attributes to attributes of other products, importance of attributes in the purchase process, timing of purchase and the level of experience with the product etc. Collaborative filtering approaches find other customers that are similar to a given customer who has purchased a given product. However, collaborative filtering and similar techniques do not take into account the reasons for a customer's purchase. Purchase transaction data provides details about purchase transactions, rather than any underlying intention behind the customer's purchase decision.

U.S. Pat. No 5,974,396, entitled “Method and system for gathering and analyzing consumer purchasing information based on product and consumer clustering relationships” and issued Oct. 26, 1999 to Andersen et al, describes grouping (i) product information into product clusters; and (ii) customers into customer clusters based on demographic information. However, this described approach involves an analysis of purchase transaction data only. This approach does not take into account the customer's reasons for making the purchase. While clustering is a useful unsupervised classification technique, the application of this technique is limited in scope.

Fuzzy techniques can be used in applications in which there is uncertainty associated with purchase behaviour. Setnes and Kaymak (in “Fuzzy Modeling of Client Preference from Large Data Sets: An Application to Target Selection in Direct Marketing”, IEEE Transactions on Fuzzy Systems, Vol. 9, No. 1, February 2001, Page no. 153-163) describe the use of a supervised learning method based on fuzzy clustering of customers for selecting target customers in direct marketing. The authors use gain curve characteristics as a criterion for selection of the most favorable customer feature to use for targeting and add customer features incrementally. However, this approach does not consider product characteristics.

Viswanathan and Childers (Understanding how product attributes influence product categorization: development and validation of fuzzy set-based measures of gradednesss in product categories, M Viswanathan and T L Childers, Journal of Marketing Research, volume XXXVI, pages 75-94, February 1999) consider product categories as fuzzy sets. Products are considered to have degrees of membership in relation to specific product attributes. All products possess all attributes to a certain degree.

In view of the above observations, a need clearly exists for an improved technique for targeting customers.

### SUMMARY

Given that customers and products have multiple attributes, and possess these attributes to different degrees, the purchase of a product by a customer has implications for knowledge of both the customer and the product. If customer A buys product B, then one can: (i) infer information about customer A's characteristics using the attributes of product B and (ii) infer information about product B's characteristics based on the attributes of customer A.

A product such as a car may be bought for style, comfort, fuel efficiency, or status. In many cases, the car that the customer currently owns may be nearing the car's useful life. A customer who buys a car that matches her status is more likely to buy a new dress that also matches her status.

If customers' disposition towards the variables influencing the purchase process can be derived, this information can be reused to target other products to the same respective customers.

Prediction techniques can use inferred information, as described above, provided this information takes into account attributes (including purchase determinants), and a method exists to infer attributes from an event such as a purchase.

An event X that relates customer A with product B in some attribute dimension has implications for both the customer and the product. The event X may be related to product viewership (window-shopping in a retail context, or click-stream details in an online context), product purchase, coupon usage, or customer feedback about the product.

Prediction techniques are described herein for targeting a product to customers based on the attributes of the product. An attribute can also be a combination of product attributes. Also, each product is assumed to possess each product attribute to a certain degree. The customers that are potential targets for a product are referred to as “target” customers for the product.

Different prediction techniques may correspond to different attributes, that is, there may be prediction techniques, which specialize in an attribute. For example, for every product in the product space, the prediction technique for an attribute provides a fuzzy set of target customers. By appropriately aggregating the fuzzy set of customers over the product space, a fuzzy set of target customers corresponding to an attribute is obtained. The product attributes that are considered in the described techniques can be accorded varying importance by the customers in the purchase of the targeted product.

Therefore, the target customers corresponding to various attributes are further weighted and aggregated to output either a single fuzzy set or a collection of fuzzy sets. The membership values in these fuzzy sets are interpreted to represent the interest of various customers in the given product. Various targeting strategies based on these fuzzy sets can be derived, depending on relevant marketing objectives.

Product attributes can be the tangible attributes of the product and/or perceptual attributes of the product (i) explicitly specified, and/or (ii) derived from the customer behaviour and/or (iii) determined otherwise from customer surveys or any other form of information gathering activity or analysis.

The described techniques can use any attribute for which one can estimate the interest of customers. Thus, a unified approach for linking both customer and product spaces through customer characteristics and product attributes is described herein.

The described techniques, based on fuzzy set theory, combine the output of various targeting or prediction tools and/or systems. Thus, various prediction strategies corresponding to various attributes of the product targeted can be taken into account.

The described techniques particularly relate to the use of an attribute-based approach (including, current or potential purchase determinants) to analyze customer interest in a product. The described techniques also particularly relate to the fuzzy aggregation of predictors that take into account various information sources.

The described techniques can derive similarity measures between products from characteristics of the customers. These similarity measures can be used for targeting of customers for a given product.

First, customer attributes of interest that are targeted to customers are identified. Different prediction techniques may correspond to different attributes. That is, there may be prediction techniques, that specialize in an attribute. For example, for every customer, the prediction technique for an attribute provides a fuzzy set of products. By appropriately aggregating the fuzzy set of products over the customer space, a fuzzy set of products corresponding to an attribute is obtained. The membership value of the product in the fuzzy set represents the attribute value for the product. Appropriate similarity measures can be defined for this new attribute in the product space and this similarity measure can be used for targeting the product to customers using the described techniques.

### DESCRIPTION OF DRAWINGS

FIG. 1 is a schematic drawing of a prediction technique that uses fuzzy logic techniques.

FIG. 2 is a schematic representation of predictor definition between a product space and a customer space to determine a mapping function that relates these two spaces.

FIG. 3 is a schematic representation of customer interest aggregation over products to obtain a single fuzzy set in the customer space.

FIG. 4 is a schematic representation of fuzzy set aggregation to obtain a single fuzzy set for each customer space of FIG. 2 for which a single fuzzy set is obtained.

FIG. 5 is a schematic representation of aggregating fuzzy sets using weights for respective fuzzy sets.

FIG. 6 is a schematic representation of nested sets mapping from the product domain to the customer domain, for two dimensions of similarity.

FIG. 7 is a schematic representation of a computer system suitable for performing technques described with reference to FIGS. 1 to 6.

### DETAILED DESCRIPTION

Techniques for targeting customers are described herein with reference to identifying target customers/markets for proposed products or marketing promotions.

In particular, the described techniques provide an example of identifying a target market for advertisements, coupons, discounts etc, for a given product p*. For example, the described techniques can be used to identify customers to whom to target an advertisement for “Mango-flavored milk containing 15% fat available in packets of 250 ml, 500 ml, and 1 lt.”

The main hypothesis of the described techniques is that if a customer is interested in a product p, then he or she is more likely to be interested in products that have similar features as those of product p.

There are two key issues arising from this hypothesis. One of these issues relates to characterizing the similarity between the features of two products and the other issue relates to determining customer interest in a product.

Various tools exist that predict a customer's interest in a given product. These tools take various types of input and use techniques such as collaborative filtering, and time series prediction to predict the customer interest. There are different ways of characterizing the similarity between products. Consequently, one can use different prediction tools to predict customer interest in products that are similar to the product under consideration. For example, in the above scenario, collaborative filtering can be used to predict customers who are interested in mango-flavored milk products, and time series prediction to predict customers who need to buy milk at that point of time.

Overview

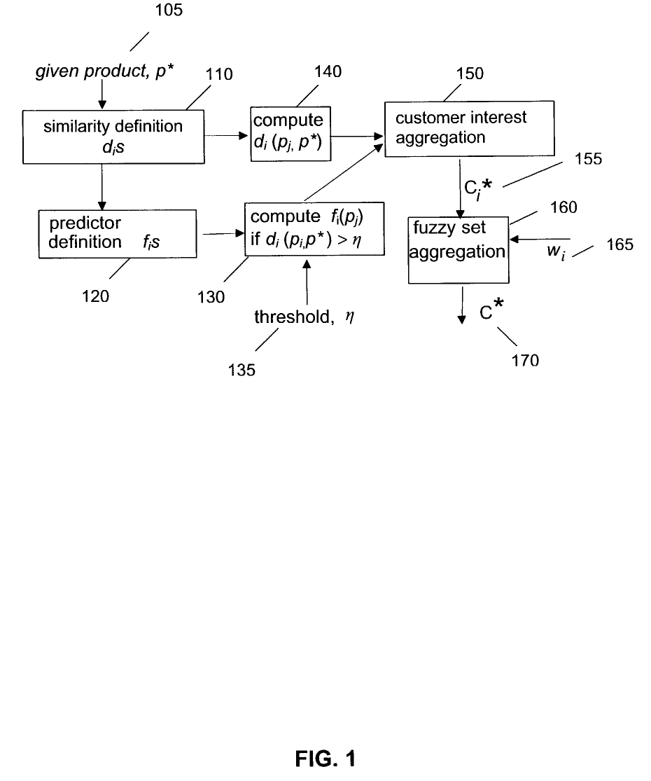

FIG. 1 schematically represents techniques that result in a single fuzzy set of customers C*. With reference to FIG. 1, let P={p₁, p₂, . . . pₘ} represent the set of m products and p* be the product for which target customers are to be determined. Let D={d₁, d₂, . . . dₙ} be n similarity measures of interest for the product p*. Let ƒ₁, ƒ₂, . . . ƒₙ be n functions corresponding to predictors associated with the similarity measures. The described techniques are now described in overview with reference to FIG. 1.

In FIG. 1, a given product p* 105 is provided for which target customers are to be determined. In step 110, similarity definition is used to define n similarity measures {d₁, . . . dₙ} relevant to product p* 105. In step 120, predictor definition defines a predictor ƒᵢ( ) for each similarity measure dᵢ. The predictors ƒᵢ( ) are represented as functions because each predictor ƒᵢ( ) maps each products pⱼ to a fuzzy set of customers Cᵢ* whose membership values represent the extent of interest of customers towards the product p*.

Similarity measures dᵢⱼ=dᵢ(pⱼ, p*) are computed in step 140. Then, the predictors ƒᵢ(pⱼ) are computed in step 130 for products that have a similarity measure dᵢⱼ greater than a threshold value η 135. Customer interest is aggregated in step 150 so predictors ƒᵢ(pⱼ) form respective customer interest sets Cᵢ* 155. Finally these Cᵢ* sets 155 are aggregated using fuzzy set aggregation in step 160 to form a single aggregated fuzzy set C* 170. The threshold value η 135 is an optional input. Also, fuzzy set aggregation can take additional inputs in form of the weights (for wᵢ, i=1, . . . n) for aggregation of the Cᵢ* sets 155.

Each of the above described steps is further described in the following correspondingly titled subsections, with reference to a particular example.

Similarity Definition

A similarity definition helps to define similarity measures that are of interest to investigate for a given product p*. Let D={d₁, d₂, . . . dₙ} be n such similarity measures. The similarity measures {d₁, d₂, . . . dₙ} can depend on one or a combination of:

tangible or intangible (for example, perceived) attributes of the product, p*

key purchasing determinants representing customer characteristics,

those derived from observed customer behavior,

those determined from customer surveys or any other form of information gathering activity or analysis.

The described techniques can use any product attribute for which one can estimate the interest of customers. If a customer buys product pⱼ with an attribute Aᵢ more often than other products, then that customer is more likely to buy another product p* that is similar to pⱼ along the product attribute dimension Aᵢ.

Similarity measures are defined based on the nature of the specific product attributes of the product. If the product attribute is numeric, one can take the absolute difference between the values of the attribute for the two products. That is, d(p, p*)=|a(p*)−a(p)| where a(p) is the value of the attribute of product p. For a nominal attribute, a predefined discrete value can be used to define the similarity.

Predictor Definition

After defining similarity measures, the customer interest towards various products with respect to each of the defined similarities are predicted. Predictor definition helps define appropriate predictors with respect to each similarity measure and various parameters associated with these predictors. Without loss of generality, the predictors can be assumed to output a fuzzy set of customers representing the extent of customer interest towards the product. Let ƒ₁, ƒ₂, . . . ƒₙ represent the fuzzy set maps of the predictors associated with respective similarity measures d₁, d₂ . . . dₙ. That is, the mapping ƒᵢ(pⱼ) represents the degree of customer interest towards product pⱼ with respect to the similarity measure dᵢ. In this case, the index i refers to similarity measure and not the customer.

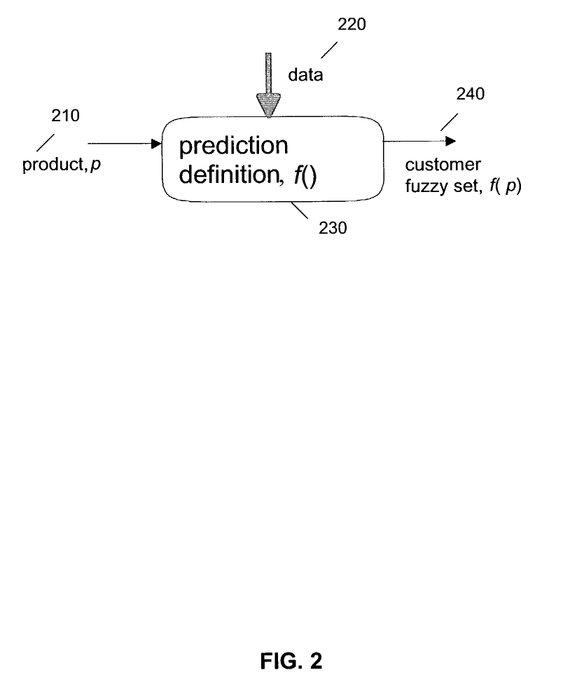

FIG. 2 schematically represents the process of predictor definition. Incoming product p 210 and data 220 are used by the prediction definition process ƒ( ) 230 to generate customer fuzzy sets ƒ(p) 240.

There are many ways of estimating ƒᵢ(pⱼ). For example, ƒᵢ(pⱼ) can be determined using a historical record of customer interest in product pⱼ, such as purchase history or advertisement response history. Corresponding to each associated pair of similarity measure and product (dᵢ, pⱼ), the merchant can select a subset of products P′ that are similar to the product pⱼ. This subset may be simply those products in the category to which pⱼ belongs. The purchase history of the customer set C in this partition P′ determines the mapping of each customer's interest in product pⱼ.

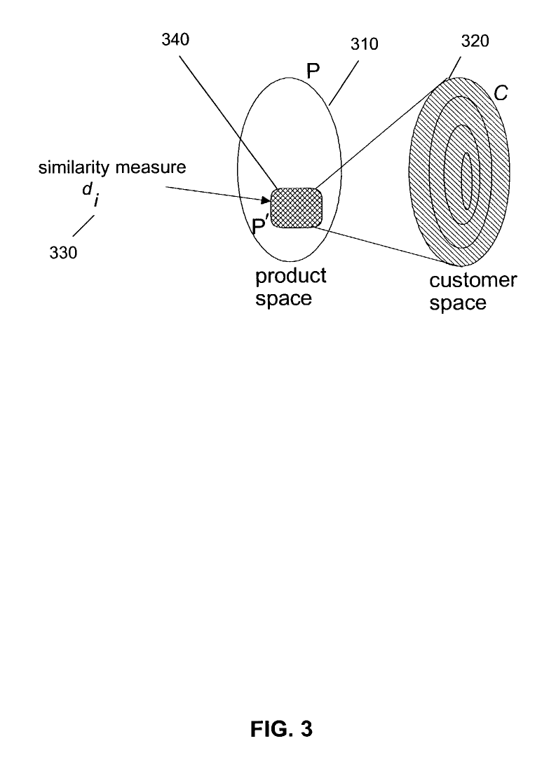

A simple implementation can be a frequency count of purchases or a time-weighted average of monetary value of purchases in partition P′. The partitioning depends on the fuzzy mapping ƒᵢ( ) and the product pⱼ, as represented in FIG. 3.

FIG. 3 represents a product space P 310 and a customer space C 320. A subset of the product space P 310 is represented by the product subset P′ 340 corresponding with product Pᵢ and similarity measure dᵢ 330.

Rules can be defined that determine this product subset P′340. The rules to determine the product subset P′ 340 can be adaptively learned using a learning algorithm, such as decision trees.

A time series prediction can be used to predict customer interest for the next time period. For example, using the purchase history (inter-purchase time between customer's purchases and historic consumption rates), the likelihood of each customer's purchase over the next time period can be predicted. Predictor ƒᵢ(pⱼ) can represent the likelihood of the customer's purchase of product pⱼ over, for example, the next week.

Customer Interest Aggregation

Customer interest aggregation obtains a single fuzzy set C* by appropriately aggregating the fuzzy sets ƒᵢ(pⱼ). The aggregation is done over products pⱼ for j=1, . . . m, which results in a single fuzzy set over the customer space for similarity dᵢ. Let Cᵢ* be the fuzzy set resulting from the aggregation, an expression for which is given directly below as Equation (1).

Cᵢ*=⊕ⱼ₌₁^{m}dᵢ(pⱼ, p*)ƒᵢ(pⱼ) (1)

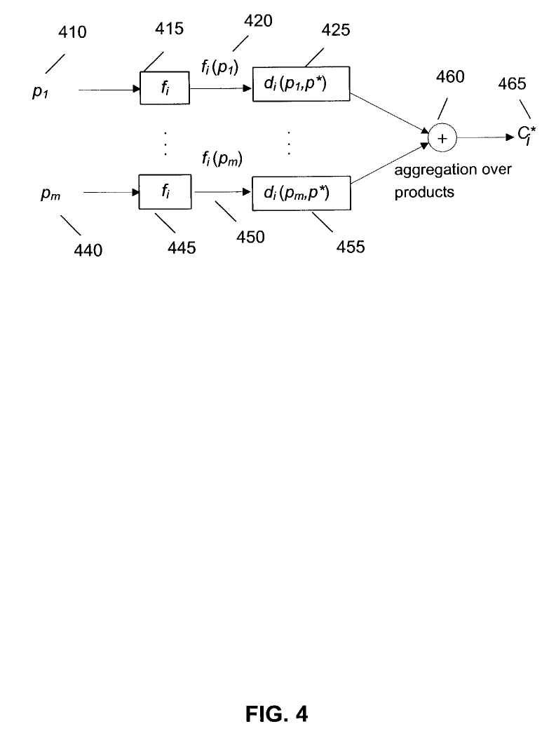

In Equation (1), ⊕ represents any of the fuzzy aggregation operators such as union or intersection. This aggregation is shown in FIG. 4. These Cᵢ* sets are of interest in making customer targeting decisions merchant to take decisions on targeting. For a product p*, Cᵢ* represents the degree of interest in p* of customers with respect to the similarity measure, dᵢ.

Fuzzy Set Aggregation

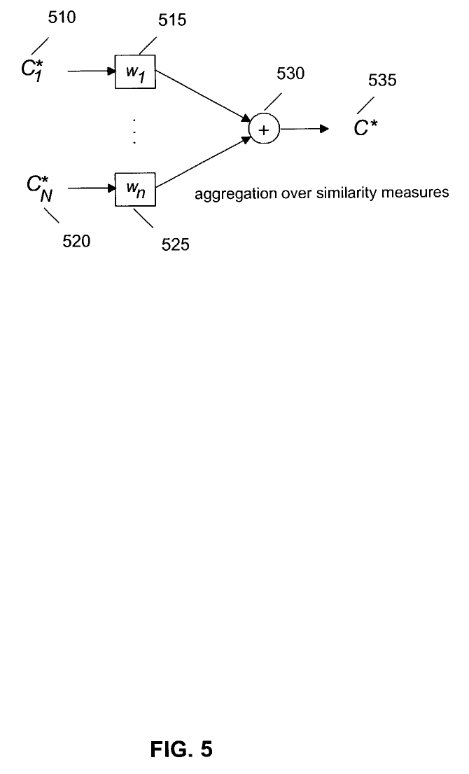

Another way to target customers is to further aggregate these Cᵢ* sets. Aggregation may result in a single fuzzy set C*. A single fuzzy set C* can be obtained by using weights (w₁, . . . wₙ) as shown in FIG. 5, which schematically represents this process. In FIG. 5, input fuzzy sets C₁* 510 to C_{N}* 520 are each multiplied with respective weights w₁ 515 to wₙ 525 respectively and aggregated 530 to produce a single fuzzy set C* 535. This process shown in FIG. 5 is equivalently represented below in Equation (2).

C*=⊕ᵢ₌₁ⁿWᵢCᵢ* (2)

Weights for aggregating fuzzy sets Cᵢ* into fuzzy set C* can be specified based on the perceived importance of the attributes in the purchase of product. These weights may be specific to each customer or a subset of customers. These weights may be specified by the merchant or obtained by using a prediction/learning tool.

Nested Subset Creation

Threshold values (also known as α-cut values or levels) can be defined for creating level-sets of the fuzzy set C* and/or Cᵢ*. For example, suppose that the merchant defines three threshold values (k₁, k₂, k₃), where k₁<k₂<k₃. These threshold values are also referred to as levels. Let C*(c) denote the membership value of customer c in fuzzy set C*. Then, three level sets of customers Cₖ₁*, Cₖ₂* and, Cₖ₃* are created in accordance with the equation, Cₖⱼ*={cεC: C*(c)≧kⱼ} for j=1, 2, 3.

Level set creation presents these sets in the form of nested subsets. In the above example, Cₖ₃*⊂Cₖ₂*⊂Cₖ₁*. These nested subsets can be used for various levels of targeting. Given the number of customers to be targeted, a threshold value or level can be defined to create a level set that contains the specified number of customers.

### EXAMPLE

Consider p*=“Mango flavored, creamy and heart-shaped biscuits” as a product. Let some of the products in the set of products P be as in the second “product description” column of Table 1. Let the 3 dimensions of similarities that are considered be: mango flavor, creamy, and shape. For each of these products pⱼ, j=1 to 6, the degree of similarity to p* is defined along each dimension and are also shown in the last three columns of

TABLE 1

| | | | Mango | | |
|---|---|---|---|---|---|
| | | | Flavor | Creamy | Shape |
| Product | Product description | Category | d₁(pⱼ, p*) | d₂(pⱼ, p*) | d₃(pⱼ, p*) |
| p₁ | Mango flavored cold drink | Cold drink | 0.7 | 0 | 0 |
| p₂ | Mango flavored ice cream | Ice cream | 0.6 | 0.5 | 0 |
| p₃ | Creamy biscuit with orange | Biscuit | 0 | 0.8 | 0 |
| | flavor | | | | |
| p₄ | Full cream milk with | Milk | 0 | 0.5 | 0 |
| | chocolate flavor | | | | |
| p₅ | Heart shaped toy | Toy | 0 | 0 | 0.6 |
| p₆ | Heart shaped gold pendant | Pendant | 0 | 0 | 0.5 |

Consider a set of 10 customers {c₁, . . . c₁₀}. Their purchase history containing the above products is as given below in Table 2.

TABLE 2

| Product | Customers who purchased this product |
|---|---|
| p₁ | c₁, c₅ |
| p₂ | c₂, c₄, c₅ |
| p₃ | c₃, c₆, c₇ |
| p₄ | c₈, c₉ |
| p₅ | c₁₀, c₄ |
| p₆ | c₃, c₂ |

For each dimension of similarity, ƒᵢ(.) is estimated as now described:

Let ƒ₁(p) represent the purchase of mango-flavored products in product category p, as a percentage of total purchases in this product category. For example, ƒ₁(p₁) is the percentage of cold drinks purchased by the customers that have a mango flavor. Assume that customer c₁ purchased 40% mango flavoured drinks, assume that customer c₃ purchased 60% mango flavoured drinks. Accordingly, ƒ₁(p₁) is of the following form:

ƒ₁(p₁)={0.4, 0, 0, 0, 0.6, 0, 0, 0, 0, 0}.

For other products, the following sets are assumed:

ƒ₁(p₂)={0, 0.6, 0, 0.3, 0.4, 0, 0, 0, 0, 0}

ƒ₁(p₃)={0, 0, 0, 0, 0, 0, 0, 0, 0, 0}

ƒ₁(p₄)={0, 0, 0, 0, 0, 0, 0, 0, 0, 0}

ƒ₁(p₅)={0, 0, 0, 0, 0, 0, 0, 0, 0, 0}

ƒ₁(p₆)={0, 0, 0, 0, 0, 0, 0, 0, 0, 0}.

Let ƒ₂(p) be the number of times customers purchased product p having an attribute “creamy” over the last month, divided by 10. That is, ƒ₂(p) is zero for all p which do not have the attribute “creamy”. Let c₃, c₆, c₇ have purchased product p₃ 4, 6, and 2 times respectively.

ƒ₂(p₃)={0, 0, 0.4, 0, 0, 0.6, 0.2, 0, 0, 0}

Also assume the following sets:

ƒ₂(p₁)={0, 0, 0, 0, 0, 0, 0, 0, 0, 0}

ƒ₂(p₂)={0, 0.2, 0.4, 0.4, 0, 0, 0, 0, 0, 0}

ƒ₂(p₄)={0, 0, 0, 0, 0, 0, 0, 0.1, 0.3, 0}

ƒ₂(p₅)={0, 0, 0, 0, 0, 0, 0, 0, 0, 0}

ƒ₂(p₆)={0, 0, 0, 0, 0, 0, 0, 0, 0, 0}.

Similarly, let ƒ₃(p) represent the amount spent on product p with a “heart shape” as a percentage of the total purchases by customers at the store.

ƒ₃(p₁)={0, 0, 0, 0, 0, 0, 0, 0, 0, 0},

ƒ₃(p₂)={0, 0, 0, 0, 0, 0, 0, 0, 0, 0},

ƒ₃(p₃)={0, 0, 0, 0, 0, 0, 0, 0, 0, 0},

ƒ₃(p₄)={0, 0, 0, 0, 0, 0, 0, 0, 0, 0},

ƒ₃(p₅)={0, 0, 0, 0.1, 0, 0, 0, 0,0,0.6}, and

ƒ₃(p₆)={0, 0.4, 0.5, 0, 0, 0, 0, 0, 0,0}.

Compute Cᵢ* as Cᵢ*=⊕ⱼ₌₁^{m} dᵢ(pⱼ, p*) ƒᵢ(pⱼ), where dᵢ is the degree of similarity. A fuzzy union (maximum membership) operator is used for ⊕ to arrive at the following fuzzy sets.

C₁*={0.28, 0.36, 0, 0.18, 0.66, 0,0,0,0,0}

C₂*={0, 0.1, 0.52, 0.2, 0, 0.48, 0.16, 0.05, 0.15, 0}

C₃*={0, 0.2, 0.25, 0.06, 0, 0,0,0,0, 0.36}

Weights are defined along each dimension i of similarity. For example, w₁=0.5, w₂=0.4, w₃=0.1. That is, the product attributes are ranked in the following descending order of importance: “mango-flavoured”, “creamy”, “heart-shaped”.

$$\begin{matrix}{C}^{*} = \sum {iC}_{i}^{*} \cdot {w}_{i} \\ = \{ 0.14 , 0.24 , 0.233 , 0.176 , 0.33 , 0.192 , 0.064 , 0.02 , 0.06 , 0.036 \}\end{matrix}$$

A high membership score for customer c in the fuzzy set C* indicates a higher degree of interest in product p*. By taking level-sets of the fuzzy set C*, one can also present the fuzzy set C* in the form of nested subsets. For example, if memberships are considered greater than or equal to 0.4, 0.3, 0.2, 0.1 and 0, the nested subsets in this case are {{φ}, {c₅}, {c₂,c₃,c₅}, {c₁,c₂,c₃,c₄,c₅,c₆}, {c₁,c₂,c₃,c₄,c₅,c₆,c₇,c₈,c₉,c₁₀}} respectively. These nested subsets can be used to offer various levels of targeting.

Nested Subsets of Target Customers Using Nested Subsets of Products

Similarity measures defined in the product space result in nested subsets of products. Suppose that the similarity measure produced by dᵢ takes only a finite number of values, such as (k₁, k₂, k₃) and k₁<k₂<k₃. Then, three subsets of products P₁, P₂ and, P₃ are formed in accordance with Equation (3).

Pⱼ={p: dᵢ(pⱼ, p*)≧kⱼ} for j=1, 2, 3 (3)

For these subsets formed in accordance with Equation (3), P₃⊂P₂⊂P₁. For example, the subsets P₁, P₂ and, P₃ can represent a set of products having a value dᵢ(p,p*)≧3, dᵢ(p,p*)≧10, and dᵢ(p,p*)≧20 respectively. Even if the similarity measure dᵢ take values from a continuous range, the levels to partition the product space can be obtained based on an information theoretic criterion. Threshold values (α-cut values can be defined) for taking level sets in both the product domain and customer domain.

The predictors ƒᵢ(pⱼ) result in “crisp” sets of customers, rather than fuzzy sets. These predictors, when applied on the nested subsets of products as defined in Equation (3), result in nested subsets of customers. Customer interest aggregation effectively aggregates (by applying Equation (1)) the sets of nested subsets of products to generate nested subsets of customers. One may note that, even when the predictors ƒᵢ(pⱼ) result in a fuzzy set, one can get nested subset of customers by taking level-sets of the fuzzy set Cᵢ* or C*. Threshold values can be defined to assign customers to different level sets and a sequence of nested subsets of customers is obtained by arranging these sets in ascending/descending order of the thresholds.

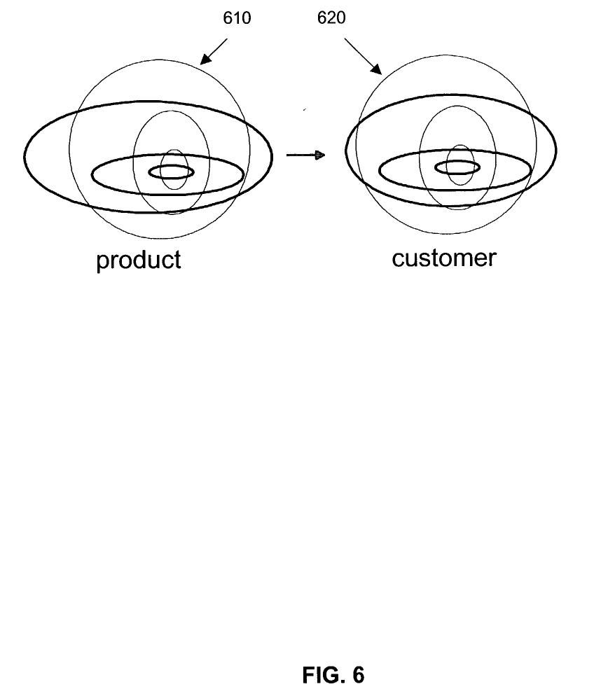

FIG. 6 represents nested subsets in both the product domain 610 and the customer domain 620. The set of nested subsets, along different measures of similarity in the product domain 610, map to different set of nested subsets in the customer domain 620.

Augmenting Product Attributes with Customer Characteristics

Similarity measures between products can be derived from characteristics of the customers. For a given product p*, customer characteristics consist of information explicitly provided by the customer and/or explicitly defined, for example, by a merchant. As an example, for a product such as a spicy thin crust pizza with mushroom, cheese, and onion, the customer characteristics may be:

a middle aged professional with dual income and no kids who prefers to consume the product in his lunch hour,

a young male, unemployed, fresh out of college, and from a medium income family, who prefers to eat the product in the evening, or

a professional who orders the product from her office during lunch or takes the product away for dinner from a restaurant.

The following technique provides a way to find a similarity measure in the product space with respect to these customer characteristics, provided an appropriate predictor that uses them exists.

The underlying hypothesis is “customers buy products that conform with their self-image”. If customers who can be classified as “modern and trendy” buy a certain product more often, then the product is likely to have an image of being “modern and trendy”. Characteristics of customers who consume the product and the manner in which they consume the product reflect the nature of the product. Various methods of creating customer segmentation generate different views of product consumption and usage. Also, a number of product attributes can be derived from the profiles of customers who buy the product.

For example, if customers purchasing a product p are characterized as quality conscious, up-market, price-indifferent customers, these characteristics can be associated with the product p. The inherent assumption is that both products and customers have a unique personality and customers buy products that reflect their personality. In this sense, unlike the collaborative filtering approach, the described techniques take into account the reason for the purchase and not just similarity in purchase patterns of customers.

A mapping from the product domain to the customer domain identifies a subset in the customer space. Characteristics of customers included in the subset, can be used to generate a profile for the product. For example, let the subset identified by a mapping be all customers who have bought groceries worth more than $1,000 from the store over the last month. Then additional attribute for Product Pi=Σ Characteristics of all.

Let δ be a customer attribute of the customer cₖ. Let {g_{δ}(cₖ, p₁), g_{δ}(cₖ, p₂) . . . g_{δ}(cₖ, pⱼ)} represent a predictor that outputs a fuzzy set of products that cₖ is interested in, with respect to the attribute δ. For example, δ may represent the annual income of cₖ. Then, g_{δ}(cₖ, pⱼ) represents the extent of interest customer cₖ has in pⱼ given his or her customer attribute of a particular annual income. One can use standard tools such as collaborative filtering as predictors. Collaborative filtering techniques find the products interesting to a customer given his/her purchase history based on the purchase history of all other customers. For example, if 3 customers have bought products A, B, C and D, and a new customer has bought products A and B, then collaborative filtering might recommend C and D to the new customer on the hypothesis that the new customer is similar to the existing 3 customers.

Each product is associated with a number using Equation (4) below.

Q(p)=(Σₖg_{δ}(cₖ, p))/M (4)

In Equation (4), M is the number of customers. Note that Q(p) represents customer characteristics in the product space for the product p. This representation has an associated similarity measure d in the product space in accordance with Equation (5) below.

d(pᵢ, pⱼ)=1−|Q(pᵢ)−Q(pⱼ)| (5)

Therefore, using Equation (5), one can use the above similarity measure d as a similarity measure and g as the corresponding predictor in (1) to find one Cᵢ*.

Computer Hardware and Software

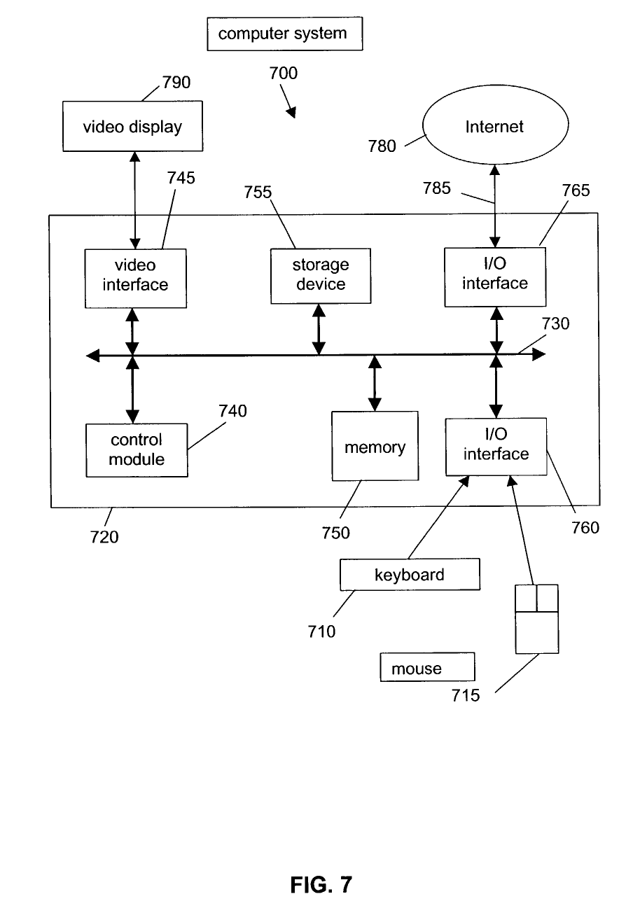

FIG. 7 is a schematic representation of a computer system 700 that can be used to perform steps in a process that implements the techniques described herein. The computer system 700 is provided for the purpose of executing computer software that is programmed to assist in performing the described techniques. This computer software executes under a suitable operating system installed on the computer system 700.

The computer software involves a set of programmed logic instructions that are able to be interpreted by the computer system 700 for instructing the computer system 700 to perform predetermined functions specified by those instructions. The computer software can be an expression recorded in any language, code or notation, comprising a set of instructions intended to cause a compatible information processing system to perform particular functions, either directly or after conversion to another language, code or notation.

The computer software is programmed by a computer program comprising statements in an appropriate computer language. The computer program is processed using a compiler into computer software that has a binary format suitable for execution by the operating system. The computer software is programmed in a manner that involves various software components, or code means, that perform particular steps in the process of the described techniques.

The components of the computer system 700 include: a computer 720, input devices 710, 715 and video display 790. The computer 720 includes: processor 740, memory module 750, input/output (I/O) interfaces 760, 765, video interface 745, and storage device 755.

The processor 740 is a central processing unit (CPU) that executes the operating system and the computer software executing under the operating system. The memory module 750 include random access memory (RAM) and read-only memory (ROM), and is used under direction of the processor 740.

The video interface 745 is connected to video display 790 and provides video signals for display on the video display 790. User input to operate the computer 720 is provided from input devices 710, 715 consisting of keyboard 710 and mouse 715. The storage device 755 can include a disk drive or any other suitable non-volatile storage medium.

Each of the components of the computer 720 is connected to a bus 730 that includes data, address, and control buses, to allow these components to communicate with each other via the bus 730.

The computer system 700 can be connected to one or more other similar computers via a input/output (I/O) interface 765 using a communication channel 785 to a network 780, represented as the Internet.

The computer software program may be provided as a computer program product, and recorded on a portable storage medium. In this case the computer software program is accessed by the computer system 700 from the storage device 755. Alternatively, the computer software can be accessed directly from the network 780 by the computer 720. In either case, a user can interact with the computer system 700 using the keyboard 710 and mouse 715 to operate the programmed computer software executing on the computer 720.

The computer system 700 is described for illustrative purposes: other configurations or types of computer systems can be equally well used to implement the described techniques. The foregoing is only an example of a particular type of computer system suitable for implementing the described techniques.

Variations

One or more product or customer attributes can change dynamically, as events take place. An event X that relates customer A with product B in some attribute dimension has implications for both the customer and the product.

The event may be related to product viewership (window-shopping in a retail context, or click-stream details in an online context), product purchase, coupon usage, or customer feedback about the product. The attributes used in the described techniques for targeting can be functions of the events, or might be learned from the events or specified otherwise. The dynamic nature of attribute values enables dynamic adaptation by the described techniques.

The techniques described herein can also be applied to determine attributes of a product that is likely to be well received by certain customers.

The described techniques are illustrated with reference to “products”. The term “product”, as used herein, includes tangible and intangible items, as well as services. For example, a product can be a digital file such as an audiovisual document.

In another implementation of the described techniques, the fuzzy set representing customer interest in different attributes of the product, Cᵢ*, can be used for determining the design of a product. The approach need not (but can) use any previous purchase history or any other type of event to compute relevant scores. The merchant can compute these fuzzy sets for different potential designs of a product and choose between competing designs depending on the number of customers whose interest in a product exceeds a predetermined threshold. The merchant can consider the whole set of customers, or a subset, when considering such decisions. The selection of a suitable subset can be a function of the fuzzy set or may include other customer features and may be an output from a learning/prediction tool.

In a further implementation, the fuzzy set representing customer interest in the i^{th} attribute, Cᵢ*, and the aggregate set C* are separately computed for different sources of information. For example, separate scores can be computed for a customer based on his or her purchase history, advertisement response history, coupon usage history, click-stream data, customer survey and other sources (6) of information. Let “R” be the number of data sources and Cᵢᵣ* represent the fuzzy scores for the i^{th} attribute, from a source “r”, as per Equation (6) below.

C*ᵢ=⊕^{R}ᵣ₌₁WᵣC*ᵢᵣ (6)

In Equation (6), ⊕ represents any one or a combination of fuzzy aggregation operators such as union or intersection. These weights for aggregation may be specific to a subset of customers and may be specified by a merchant or generated with the help of a prediction/learning tool.

Various other alterations and modifications can be made to the techniques and arrangements described herein, as would be apparent to one skilled in the relevant art.

We claim:

1. A method for identifying customers interested in a product, the method comprising the steps of:
(i) identifying one or more product attributes of a product;
(ii) determining, for each identified product attribute, fuzzy sets that represent respective customer interest in said respective identified product attributes;
(iii) aggregating said fuzzy sets to obtain a single aggregated fuzzy set that represents, for respective customers, a degree to which respective customers are interested in said product.

2. The method as claimed in claim 1, further comprising the step of identifying customer's interested in the product on the basis of said aggregated fuzzy set.

3. The method of claim 1, wherein said step (ii) of determining fuzzy sets further comprises the step of using recorded customer behaviour to determine respective customer's interest towards said respective identified product attributes.

4. The method as claimed in claim 3, wherein said customer behaviour comprises one or more of the following: browsing or seeking information concerning products with said product attributes, purchasing products with said product attributes, participating in an auction for products with said product attributes, using coupons for products with said product attributes, viewing advertisements for products with said product attributes, and participating in promotions for products with said product attributes.

5. The method as claimed in claim 1, further comprising the step of presenting the product to customers using audiovisual media.

6. The method as claimed in claim 5, wherein the audiovisual media comprises any one or more of advertisements, coupons, and surveys.

7. The method as claimed in claim 1, wherein said identified product attributes comprise tangible and/or intangible attributes of said product.

8. The method as claimed in claim 7, wherein said identified intangible product attributes can be: (i) specified by the merchant, or (ii) derived from customer behavior or (iii) otherwise determined from information provided by customers.

9. The method as claimed in claim 1, wherein categories of customers with differing levels of interest in the product can be obtained by determining a set of nested subsets calculated by taking level-sets of the resulting fuzzy set.

10. The method as claimed in claim 1, wherein said identified customers interested in the product are identified as a set of nested subsets of customers.

11. The method as claimed in claim 1, further comprising the step of offering to said identified customers a coupon that represents a discount whose amount is determined by said respective customer's interest in said product.

12. The method as claimed in claim 1, further comprising the step of determining the size, frequency and content of advertisements to be shown to said respective customer based on said respective customer's interest in said product.

13. The method as claimed in claim 1, further comprising the step of determining the design of a product based on the number of customers whose interest in said product exceeds a predetermined threshold.

14. The method as claimed in claim 1, further comprising the step of enhancing the product attributes based on the customer characteristics.

15. The method as claimed in claim 1, wherein said identified customers interested in the product are identified by the steps comprising:
determining an appropriate measure of similarity between the product, and other products that are members of a predetermined set of products;
determining, for each of said products, fuzzy sets that represent respective customer's interest in products of said predetermined set of products;
assigning said measures of similarity between products of said predetermined set of products as weights with which said fuzzy sets can be aggregated; and
aggregating said fuzzy sets of customers for said predetermined set of products using said assigned weights.

16. The method as claimed in claim 15, wherein said fuzzy set of customers is determined using techniques that learn from external events.

17. The method as claimed in claim 16, wherein said external events comprise any one or more of customer behavior, marketing inputs, introduction of new products, and changes in competitive scenario.

18. The method as claimed in claim 15, wherein said customers and said products have respective profiles that change in response to external events.

19. The method as claimed in claim 18, wherein said external events comprise any one or more of: customer behavior, marketing inputs, introduction of new products, and changes in competitive environment.

20. The method as claimed in claim 15, wherein said weights for aggregating the fuzzy set of customers are determined by a learning or prediction tool.

21. The method as claimed in claim 1, further comprising the step of: determining at least some of the product attributes based upon customer characteristics.

22. The method as claimed in claim 21, wherein the step of determining at least one product attribute based upon customer characteristics comprises the steps of:
(i) determining, for each customer having a particular customer characteristic, a fuzzy set of products in which the customer is interested;
(ii) aggregating such fuzzy sets of products for customers having the particular customer characteristic, to obtain a single aggregated fuzzy set; and
(iii) determining a value of the product attribute for a product as a degree to which the respective product belongs to the aggregated fuzzy set.

23. A computer software program for identifying customers interested in a product, recorded on a medium and capable of execution by computing means able to execute the computer software program, the computer software program comprising:
(i) software code means for identifying one or more product attributes of a product;
(ii) software code means for determining, for each identified product attribute, fuzzy sets that represent respective customer's interest attributable said respective identified product attributes;
(iii) software code means for aggregating said fuzzy sets to obtain a single aggregated fuzzy set that represents said respective customer's interest in said product.
